(19) United States
(12) Patent Application Publication
(10) Pub. No.: US 2013/0031052 A1
(43) Pub. Date: Jan. 31, 2013

(54) Automated Database-Population Tool

(71) Applicant: Joshua LUBIN, Silver Spring, MD (US)

(72) Inventor: Joshua LUBIN, Silver Spring, MD (US)

(73) Assignee: Crowell & Moring, LLP, Washington, DC (US)

(21) Appl. No.: 13/560,140

(22) Filed: Jul. 27, 2012

Related U.S. Application Data
(60) Provisional application No. 61/512,227, filed on Jul. 27, 2011.

(51) Int. Cl. G06F 17/30

(52) U.S. Cl. 707/627; 707/825; 707/E17.005

(57) ABSTRACT

An Internet-based web application with a database back-end that processes user-entered data to automatically carry out various functions such as updating database tables, communicating with employees, reserving office space, assigning personal identification number, and any number of tasks required to properly manage employees and their information. The application is superior to repetitive manual entry of duplicative data into each employee database that a company manages while efficiently coordinating the various departmental functions required to modify the status and information of new, existing, and departing employees. The application efficiently updates all systems within the company as needed and interacts with users when information is needed from those users at various points in the process.

### CROSS-REFERENCE TO RELATED APPLICATIONS

This application claims priority under 35 U.S.C. §119(e) to U.S. provisional application Ser. No. 61/512,227, filed Jul. 27, 2011, the entire disclosure of which is incorporated by this reference into the present application.

### BACKGROUND AND SUMMARY OF THE INVENTION

This invention generally relates to Internet-based web applications with database back-ends, and, in particular, to software applications in which a user enters relevant data and the related computer software automates background processes to carry out various functions. This invention is particularly useful in relation to processing human resources data related to new hires at a company and employees leaving a company; however, it should be understood that the invention is intended for broader applications and use.

The present invention involves an Internet-based web application with a database back-end that processes user-entered data to automatically carry out various functions. Particularly, the invention makes more efficient the process of getting a newly hired employee, i.e., a “new hire”, from acceptance through his or her first day of work. This process is called “on-boarding”. Alternatively, the invention makes more efficient the process of getting a current employee leaving a company, i.e., a “departing employee”, ready for departure. This process is called “off-boarding”. The invention is superior to repetitive manual entry of duplicative data into each employee database that a company manages while efficiently coordinating the various departmental functions required to prepare for a new hire's first day at a company or a departing employee's final day at a company. Moreover, the invention can be used to easily modify the status and information of existing employees who are not departing a company. For example, when a current employee's status changes due to marriage, the birth of a child, or a name change, the invention can automatically access and update each relevant database with the changed information. This could include, for example, updates to payroll, benefits, and insurance. To the extent a current employee's status changes throughout the course of employment, the invention can be used to efficiently update all systems within the company to reflect this status change.

### BRIEF DESCRIPTION OF THE DRAWINGS

FIG. 1 illustrates one embodiment of a primary workflow involving consoles that each correspond to various steps in the primary workflow or secondary workflow where a user enters data pertinent to the new hire or departing employee;

FIG. 2 illustrates the rights of a user, an authorized user, and an owner with respect to a console;

FIG. 3 illustrates an embodiment of a primary workflow involving a number of consoles that each correspond to a specific step in the primary workflow or secondary workflow where a user enters data pertinent to the new hire or departing employee;

FIG. 4 is a summary of the names, dependencies, outputs, and systems updated of the consoles corresponding to those consoles as illustrated according to FIG. 3.

### DETAILED DESCRIPTION OF THE INVENTION

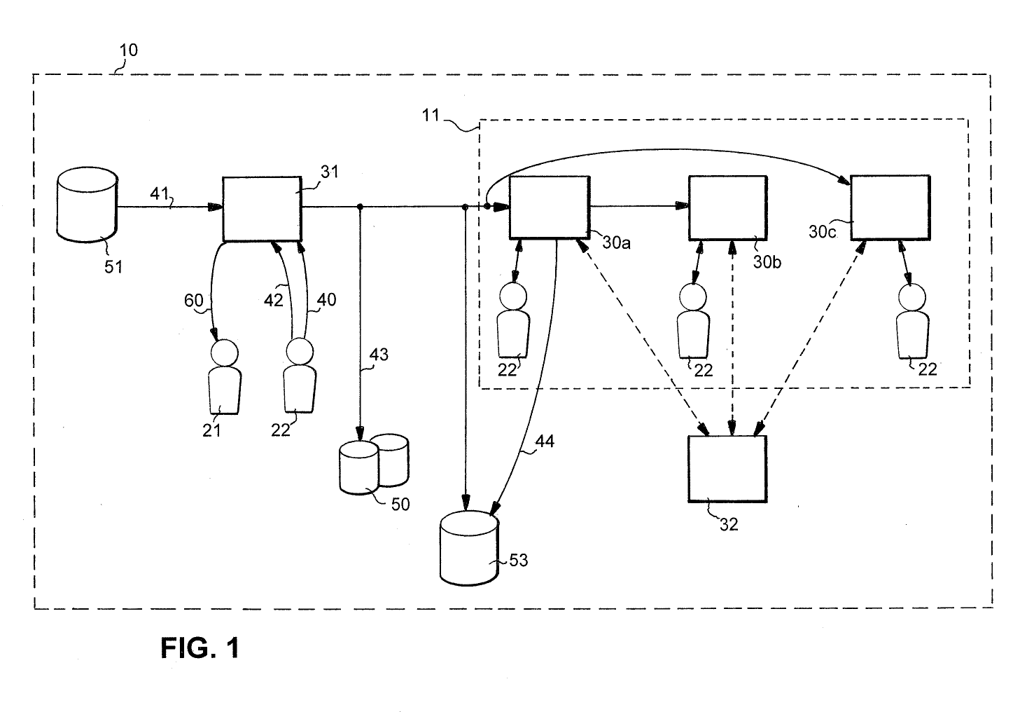

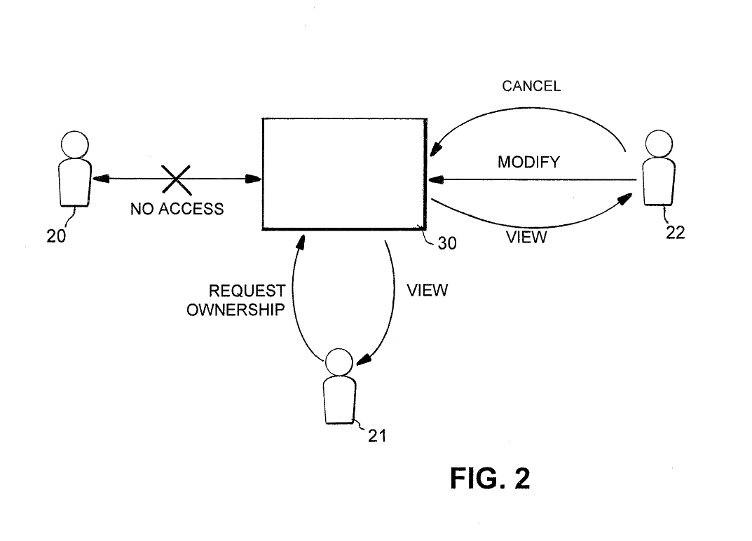

FIG. 1 illustrates a primary workflow 10 that represents the steps from the time either (a) a new hire receives an offer of employment until the new hire is fully integrated into the company's database systems or (b) a departing employee gives notice of departure until the departing employee is fully processed for departure in the company's database systems. Each step in the primary workflow 10 is represented as various consoles 30a, 30b, 30c, 31, which are described herein. At each console 30a, 30b, 30c (referred to generally herein as consoles 30), users 20 (illustrated in FIG. 2), 21, 22 interact with consoles 30, 31 by entering data 40 or completing specific tasks required by the consoles 30, 31. The consoles 30, 31 represent processes in the primary workflow 10 and are not limited by interaction with users 20, 21, 22. The primary workflow 10 preferably stores all activities by users 20, 21, 22 for each respective console in the primary workflow 10 in an activity tracking table (not illustrated). The activity tracking table is a database table that stores a record of every event in which a user 20, 21, 22 provides, modifies, or deletes data within the consoles 30, 31. The primary workflow 10 also preferably stores all alerts and notifications sent by the consoles 30, 31 in an alert tracking table (not illustrated). The alert tracking table is a database table that stores a record of every communication (e.g., email) sent to a user 20, 21, 22 prompting the user 20, 21, 22 to view the consoles 30, 31 or take an action in the consoles 30, 31.

The primary workflow 10 typically begins with a New Hire Verification console 31, an external table 51, and a triggering process (not illustrated). The New Hire Verification console 31 may be of a similar type as any one of consoles 30; however, any suitable type of console may be used. The external table 51 is a database that typically holds basic information about a new hire who has been given an offer for employment but has not yet accepted his or her offer of employment. The control of external table 51 and the entry of information therein is typically controlled by an external application. The triggering process recognizes when new entries are entered into external table 51, meaning a new hire has been extended an offer of employment. The triggering process then moves initial data 41 contained in that new entry from the external table 51 to the New Hire Verification console 31. Until this point, the New Hire Verification console 31 is in a pending state and waits for the triggering process to send it initial data 41, which may include name, home address, home and cell phone numbers, work location, and company of the new hire, or any other relevant information.

The consoles 30, 31 may be in a pending state, and thereby may be called dependent consoles, if they are waiting on one or more predecessor consoles and the consoles 30, 31 cannot complete their designated tasks. In FIG. 1, for example, console 30b may be called a dependent console and console 30a may be called a predecessor console, because in that example, console 30b cannot complete its designated tasks until console 30a is complete. In FIG. 1, console 30c does not have a dependency relationship with consoles 30a, 30b. In some cases an owner 22 may forego waiting on the one or more predecessor consoles so that the dependent console can immediately proceed with its designated tasks.

An owner 22 and an authorized user 21 are specific types of users who are authorized to access any one of consoles 30, 31. The consoles 30, 31 have their own security management process (not illustrated) that limits access to the consoles 30, 31 to only an authorized user 21 or an owner 22 based on a variety of characteristics of a user 20, 21, 22. In this way, not every user 20, 21, 22 have full access rights to every one of the consoles 30, 31. An authorized user 21 may only view the data associated with the consoles 30, 31 for which he or she is authorized by that console's security management process. Unlike an authorized user 21 who only has rights to view associated data, an owner 22 of any one of the consoles 30, 31 may view and modify the data associated with that console 30, 31. The owner 22 may also cancel the console 30, 31, thereby skipping that console 30, 31 in the primary workflow 10. Depending on the characteristics of an authorized user 21, the authorized user 21 may become an owner 22 of any one of the consoles 30, 31 by requesting to be an owner 22. FIG. 2 is an illustration of the rights of a user 20, an authorized user 21, and an owner 22 in relation to the consoles 30. It should be noted that the security rights of a user 20, 21, 22 are based on the specific consoles 30, 31, and may vary between consoles 30, 31. As an example, an owner 22 of console 30a may be an authorized user 21 of console 30b but merely a user 20 of console 30c.

When the triggering process sends initial data 41 to the New Hire Verification console 31, the New Hire Verification console 31 may communicate 60 with an authorized user 21 to access the New Hire Verification console 31 and confirm acceptance 42 of the new hire. In order to confirm acceptance 42 of the new hire, the authorized user 21 typically requests to be an owner 22 of the New Hire Verification console 31. Once the authorized user 21 or owner 22 confirms acceptance 42 of the new hire, the New Hire Verification Console 31 moves to an in-progress state. Any one of the consoles 30, 31 is said to be in an in-progress state when it is waiting for an owner 22 to provide data 40 pertinent to the new hire that is required by that console 30, 31. For a console 30, 31 in a pending state or an in progress state, it is possible for a scheduling polling process (not illustrated) to notify an owner 22 of that console 30, 31 that the console 30, 31 has been dormant for a period of time, and prompt the owner 22 to complete the tasks required by that console 30, 31.

Alternatively, an owner 22 can move the New Hire Verification console 31 from a pending state to an in-progress state by manually providing basic information about the new hire to the New Hire Verification console 31 and confirming acceptance of the new hire. There is no need to wait for the external table 51 or the triggering process.

Once the owner 22 confirms acceptance of the new hire by either method described above, the New Hire Verification console 31 waits for the owner 22 to enter data 40 about the new hire, which can include personal information, orientation setup, job information, organization setup, compensation/payroll setup, staff timesheet setup, provisioning setup, education, previous employment, resume/offer letter attachments, and firm distribution lists, or any other relevant information. After the owner 22 enters the required data 40, the New Hire Verification console 31 moves to a completed state. Any one of the consoles 30, 31 is said to be in a completed state if the owner 22 associated with that console 30, 31 has entered all required data 40 into the console 30, 31 and the console 30, 31 has completed all internal processes associated with that console 30, 31. When any one of the consoles 30, 31 is in a completed state, an owner 22 must take special measure to modify the data 40 associated with that console 30, 31. As long as the owner 22 does not take this special measure, the owner 22 and authorized users 21 only have rights to view the data 40 previously entered by an owner 22 and associated with that console 30, 31 when the console 30, 31 is in a completed state.

In the embodiment represented in FIG. 1, the New Hire Verification console 31 serves as a “catalyst” for the other consoles 30 in the primary workflow 10; however, the present invention is not limited to the particular configuration listed in the example of FIG. 1. In this particular example, the consoles 30 may not run until the New Hire Verification console 31 moves to a completed state. This is because the New Hire Verification console 31 does several things:

First, the New Hire Verification console 31 populates a number of database tables 50 with the data 43 provided by the owner 22. These database tables 50 are accessible by all other consoles 30 so that those consoles 30 can access the data 43 at a later time in the primary workflow 10. The New Hire Verification console 31 gives to each new hire a unique identifier so that the data 43 on these database tables 50 is unique to each new hire.

Second, the New Hire Verification console 31 assigns the new hire a unique employee number/timekeeper ID for identification within the company. The New Hire Verification console 31 does this by determining the next available number from an external listing of unique employee numbers/timekeeper IDs as part of the firm's accounting & billing system.

Third, the New Hire Verification console 31 creates the new hire's timekeeper record for client billing purposes. Depending on the data 40 entered by the owner 22, the New Hire Verification console 31 may create a personal matter client and matter number and a vendor record for the new hire, or any other suitable identifying information.

Fourth, the New Hire Verification console 31 generates an email or any other suitable form of communication containing basic information about the new hire and the terms of the new hire's employment, which may include name, title, office/location, and start date, or any other relevant information. After generation, the New Hire Verification console 31 sends this email or other suitable form of communication to a number of appropriate internal employees so that they can be ready for the new hire on his or her expected arrival date.

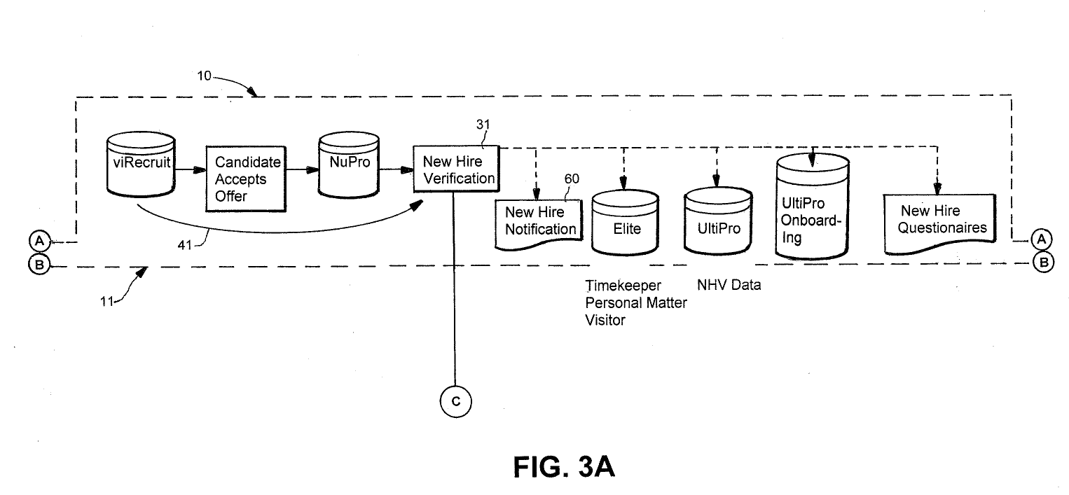

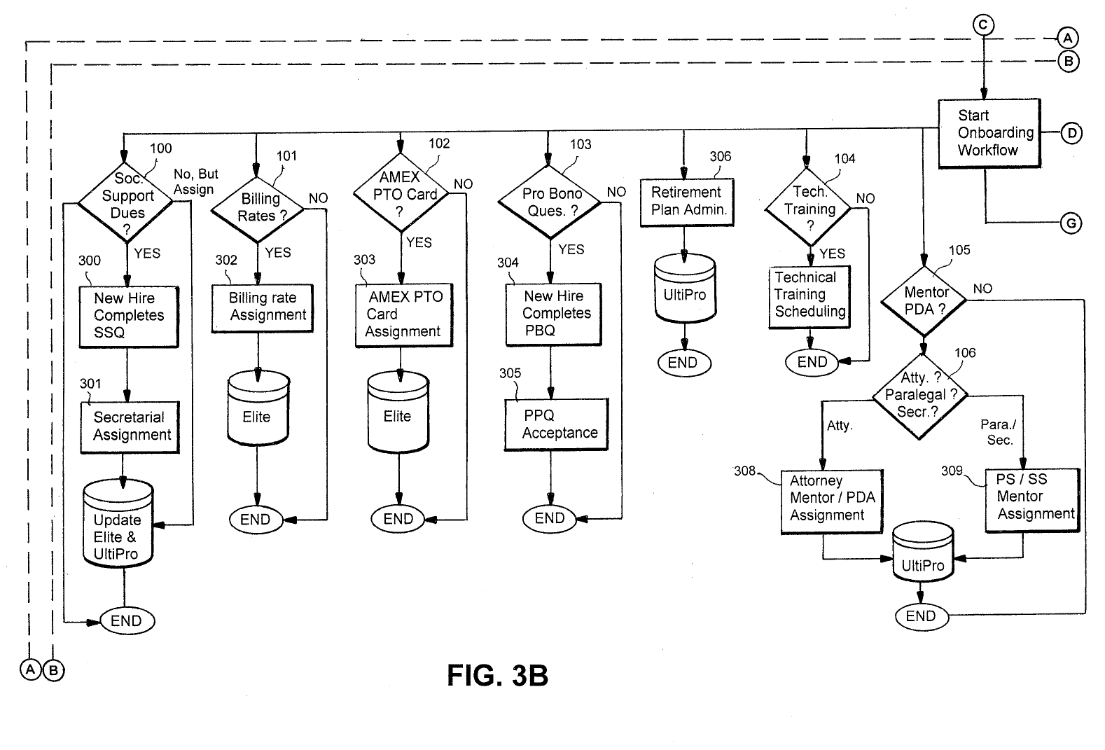

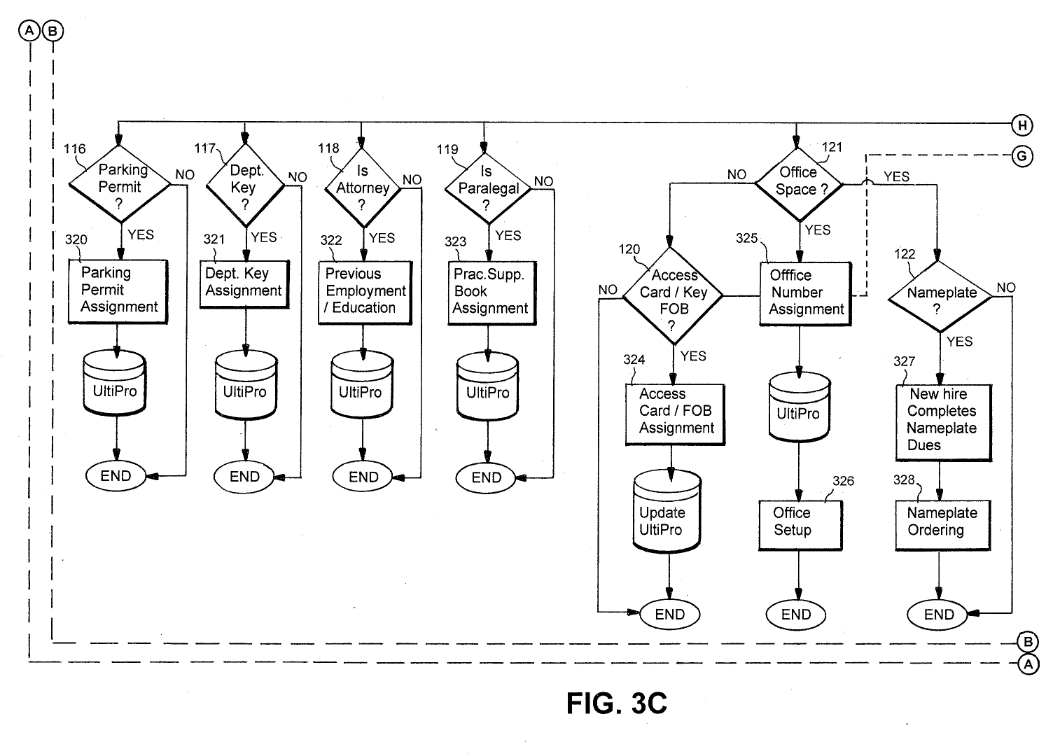

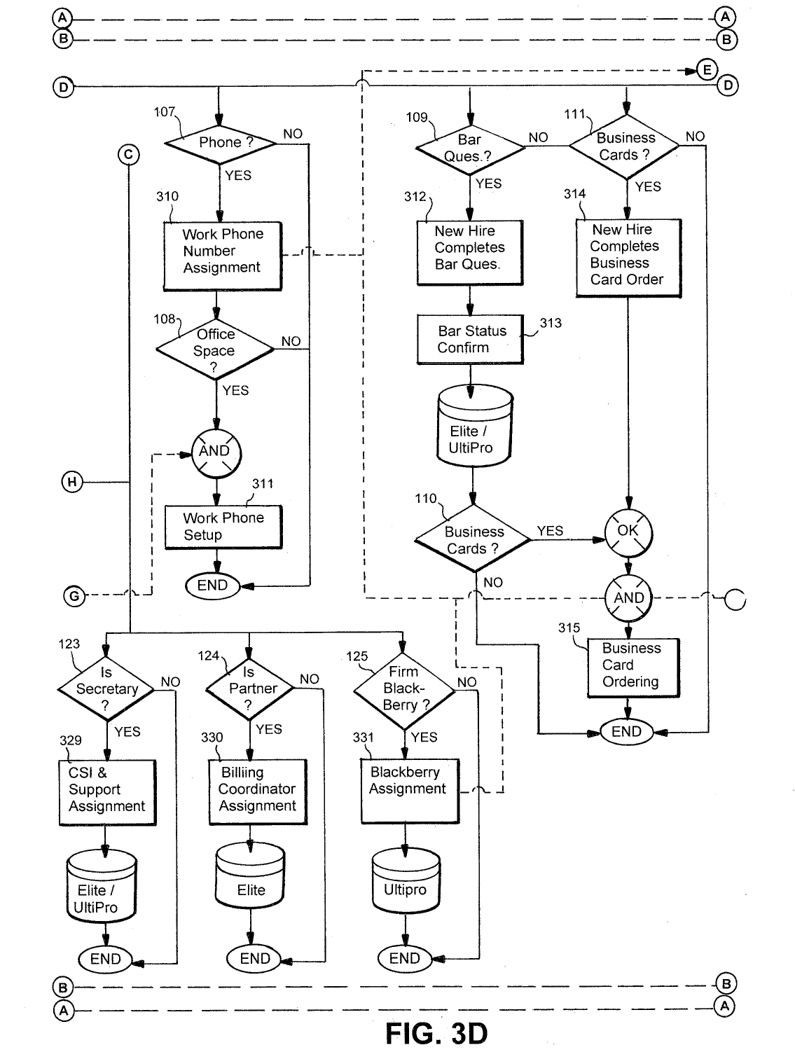

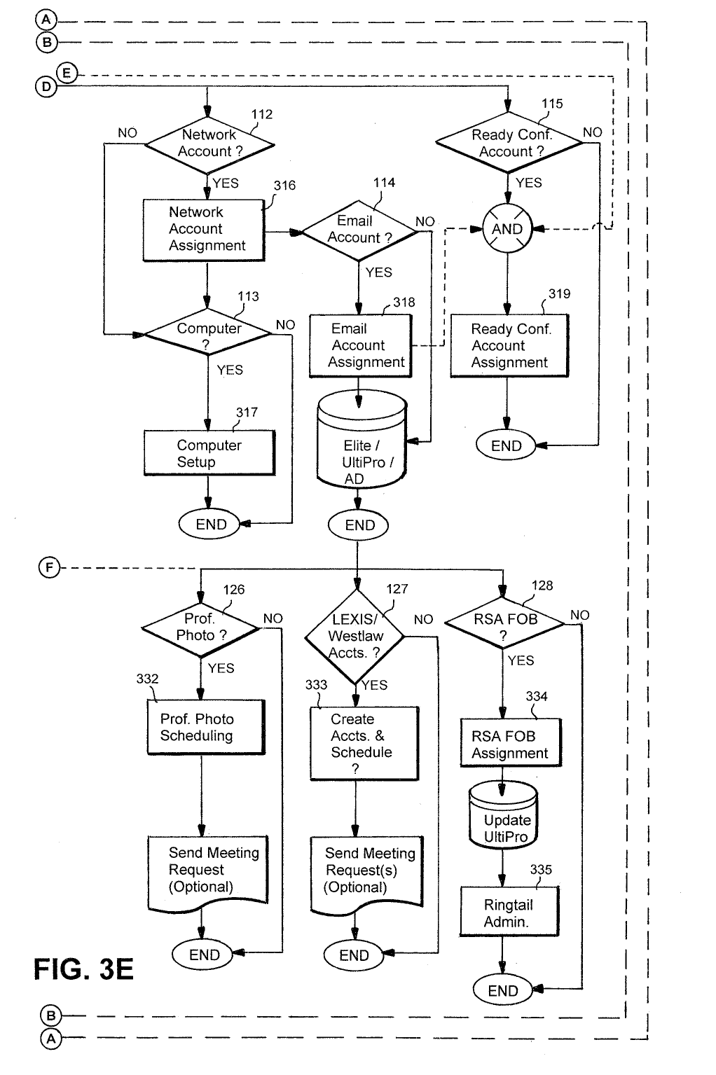

Fifth, if the new hire is required to complete one or more on-line questionnaires, the New Hire Verification console 31 generates an email or any other suitable form of communication and sends that email or other suitable form of communication to the new hire. The email or other suitable form of communication may contain a link that, when clicked, gives the new hire access to a questionnaire the new hire is to complete. The questionnaire may include questions regarding Secretarial Support 300, Bar Status 312, Pro Bono 304, Business Card 314, and/or Nameplate 327 (illustrated in FIG. 3), or any other relevant questions.

Sixth, if a referral bonus or sign-on bonus is to be paid to the new hire or to another employee, the New Hire Verification console 31 generates an email or any other suitable form of communication and sends the email or other suitable form of communication to the payroll department.

Seventh, the New Hire Verification console 31 inserts a record into a data sync table 53. The data sync table 53 is a database that keeps track of the processes that cannot be completed at the time of entry, but need to be completed at a later date or time. For example, at the time the New Verification console 31 runs, the new hire has not yet started employment with the company. There are databases that cannot be updated or processes cannot run until the new hire has started employment with the company. In these circumstances, the data sync table 53 maintains a record of these tasks to be completed when the new hire has started employment with the company. Each record in the data sync table 53 holds a unique combination of the unique identifier, a process to be completed, and a database to be updated. A background polling process (not illustrated) polls the data sync table 53 once every hour to check for entries marked as “complete”. Once the record in the data sync table 53 is marked as “complete” by any one of the consoles 30, 31, the background polling process completes the process as described in the entry, and updates the database with the appropriate data, and inserts a date/time stamp into the record to reflect when the background polling process processed the record.

Eighth, the New Hire Verification console 31 sends data (not illustrated) entered by an owner 22 to an external system (not illustrated) that may complete various other processes, such as sending the new hire a link complete documentation work documentation, including 1-9, W-4, direct deposit form, computer usage policy sign-off, and any other relevant information.

Ninth, the New Hire Verification console 31 sends initial notifications (not illustrated) to a number of authorized users 21 who may be required to become owners 22 and enter data 40 in any one of the consoles 30, 31 for the new hire on-boarding.

Finally, and depending on the data 40 the owner 22 enters into the New Hire Verification console 31, the New Hire Verification console 31 determines a secondary workflow 11 to start after the New Hire Verification console 31 moves to a completed state. The secondary workflow 11 represents a subset of the primary workflow 10 after the New Hire Verification console 31 moves to a completed state and is a specific and ordered series of the consoles 30 to be completed. It is noted that the example shown in FIG. 1 illustrates three consoles, 30a, 30b, and 30c in the secondary workflow 11; however, any suitable number or combination of consoles with any dependency relationships may be used. Alternatively, the owner 22 of the New Hire Verification console 31 may manually modify the secondary workflow 11. The variables that affect the secondary workflow 11 may include one or more of the following requirements or any other suitable requirements:

| | |
|---|---|
| Office Setup | Lexis/Westlaw Accounts |
| Nameplate | RSA FOB Assignment |
| Access Card/Key FOB | Business Cards |
| Department Key | Professional Photograph |
| Parking Permit | Billing Rates |
| Computer | Personal Matter Assignment |
| Network Account | AMEX PTO Purchasing Card |
| Email Address | Secretarial Support Questionnaire |
| Technology Training | Bar Questionnaire |
| Work Phone Number | Pro Bono Questionnaire |
| Firm Blackberry | Mentor/PDA Assignment |
| Ready Conference Account | |

Once the New Hire Verification console 31 has moved to a completed state, the secondary workflow 11 begins. It is possible after the New Hire Verification console 31 has moved to a completed state that the owner 22 of the New Hire Verification console 31 can modify any of the data 40 entered during the New Hire Verification Console 31. Similarly, for each console 30 in the secondary workflow 11, it is possible after the console 30 has moved to a completed state that the owner 22 of the console 30 can modify any of the data 40 entered during that console 30, explained more fully herein.

At this point, the primary workflow 10 starts an On-Boarding Status console 32. The On-Boarding Status console 32 is accessible by an authorized user 21 or owner 22 and compiles and displays the progress of the consoles 30 selected for the secondary workflow 11, sends alerts from the consoles 30 selected for the secondary workflow 11 to a number of owners 22 to complete the consoles 30 that are waiting for an owner 22 to enter data, displays data entered by any owner 22 in the consoles 30 in the secondary workflow 11, and generates a New Hire Fact Sheet (not illustrated). The New Hire Fact Sheet summarizes the information a new hire needs to know when they begin employment with the company. The New Hire Fact Sheet may include such information as phone number, email address, network login ID, secretarial assignment, billing rate(s), and office number, or any other relevant information.

As each of the consoles 30 in the secondary workflow 11 moves to a completed state, the consoles 30 may insert a record 44 into the data sync table 53. The process for the consoles 30 is the same as the process described above specifically for the New Hire Verification console 31: The data sync table 53 is a database table that keeps track of the processes that cannot be completed at the time of entry, but need to be completed at a later date or time. For example, at the time the console 30 runs, the new hire has not yet started employment with the company. There are databases that cannot be updated or processes cannot run until the new hire has started employment with the company. In these circumstances, the data sync table 53 maintains a record of these tasks to be completed when the new hire has started employment with the company. Each record in the data sync table 53 holds a unique combination of the unique identifier, a process to be completed, and a database to be updated. A background polling process (not illustrated) polls the data sync table 53 once every hour to check for entries marked as “complete”. Once the record in the data sync table 53 is marked as “complete” by the consoles 30, the background polling process completes the process as described in the entry, and updates the database with the appropriate data, and inserts a date/time stamp into the record to reflect when the background polling process processed the record.

A completion polling process (not illustrated) polls the secondary workflow 11 every night to determine if the last console in the secondary workflow 11 is in a completed state. If the last console in the secondary workflow 11 is in a completed state, the completion polling process marks the primary workflow 10 and the secondary workflow 11 as complete.

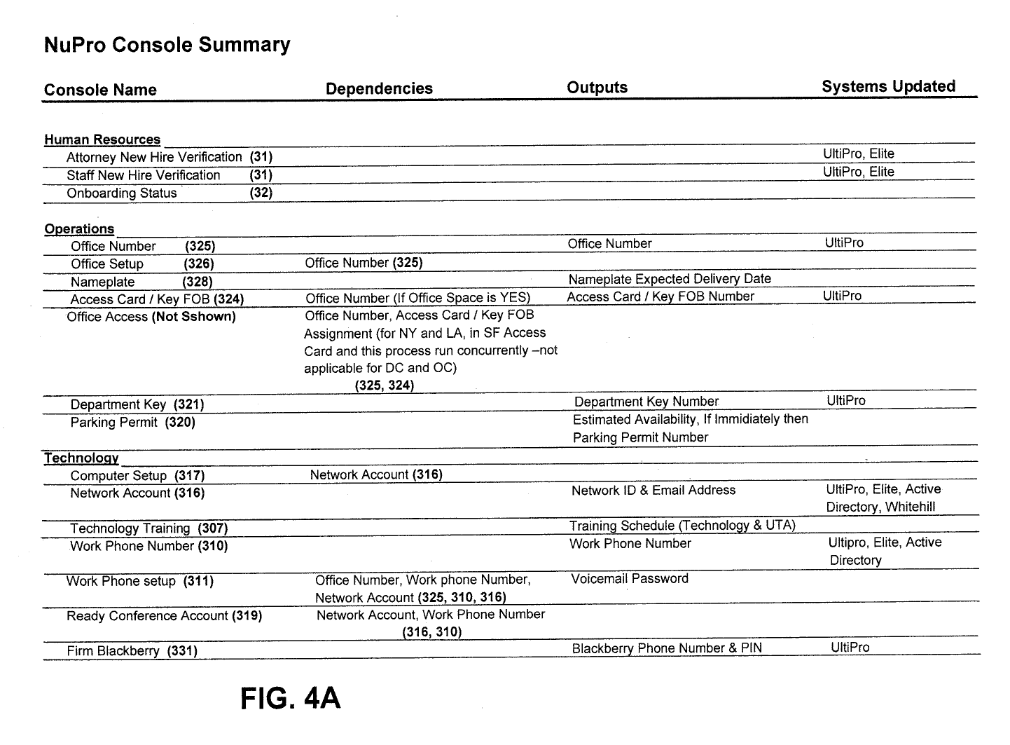

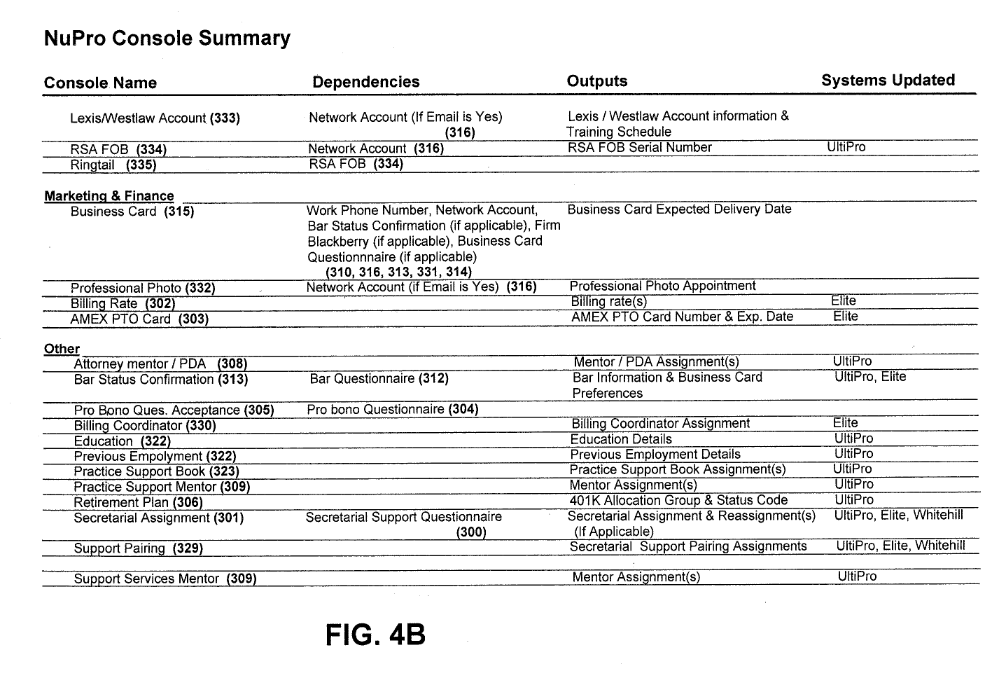

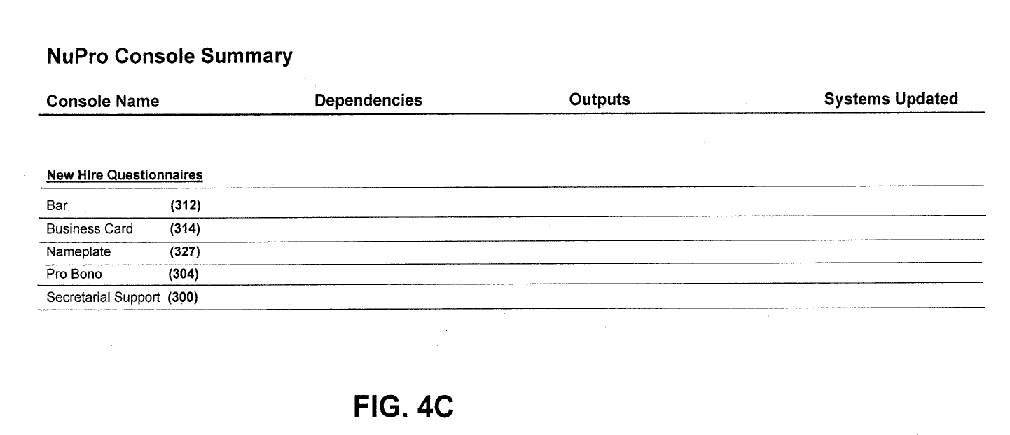

FIG. 3 illustrates a detailed example of one embodiment of a primary workflow 10, although different configurations may be used depending on the application of the invention. When the candidate accepts his or her offer, the triggering process (not illustrated) sends initial data 41 to the New Hire Verification console 31 from the external table 51. The New Hire Verification console 31 notifies 60 an authorized user (not illustrated) to access the New Hire Verification console 31 and confirm acceptance of the new hire. After the New Hire Verification console 31 moves to a completed state as described with respect to FIG. 1 above, the New Hire Verification console 31 determines the secondary workflow 11 based on a series of variables. As an example, based on a secretarial support requirement 100, the secondary workflow 11 may include the New Hire Completes SSQ console 300 and the Secretarial Assignment console 301. Based on a new hire's billing rates requirement 101, the secondary workflow 11 may include the Billing Rate Assignment console 302. Similarly, based on the new hire's office space 121, access card/key FOB 120, and nameplate 122 requirements, the secondary workflow 11 may include the Access Card/FOB Assignment 324, Office Number Assignment 325, Office Setup 326, New Hire Completes Nameplate Questionnaire 327 and/or Nameplate Ordering 328 consoles. This example continues for all requirements 100 to 128 and all consoles 300 to 335 of the embodiment in FIG. 3. FIG. 4 is a related summary of all consoles 300 to 335 represented in one embodiment of the invention as shown in FIG. 3. FIG. 4 shows the dependencies between each dependent console and predecessor console, as well as the outputs of each console 300 to 335 and the systems updated in that embodiment.

As briefly described above, after the New Hire Verification console 31 or any of the consoles 30 in the secondary workflow 11 move to a completed state, it is possible that the owner 22 of the New Hire Verification console 31 or owner 22 of that console 30 in the secondary workflow 11 can modify any of the data 40 entered in the New Hire Verification console 31 or the console 30 in the secondary workflow 11. When this happens, the console 30, 31 may insert a record 44 into the data sync table 53, holding a unique combination of the unique identifier, a process to be completed, and a database to be updated. A background polling process (not illustrated) polls the data sync table 53 once every hour to check for entries marked as “modified”. Once the record in the data sync table 53 is marked as “modified” by the consoles 30, 31, the background polling process completes the process as described in the entry, updates the database with the appropriate data, updates the On-Boarding Status console 32 to update the order or progress of the consoles 30 selected for the secondary workflow 11, and inserts a date/time stamp into the record to reflect when the background polling process processed the record.

Although the invention has been described and illustrated in detail, it is to be clearly understood that same is by way of illustration and example, and is not to be taken by way of limitation. The spirit and scope of the present invention are to be limited only by the terms of the appended claims.

What is claimed is:

1. A method for automatically populating a human resources database, comprising:
providing a primary console and one or more secondary consoles;
restricting access to the primary console and at least one of a plurality of secondary consoles based on a set of security limitations;
entering employee data into the primary console and said at least one of a plurality of secondary consoles;
processing the employee data entered into the primary console;
processing the data in said at least one of a plurality of secondary consoles after data are processed in the primary console; and
populating employee databases related to the primary and said at least one of a plurality of secondary consoles.

2. The method for automatically populating a human resources database of claim 1, further comprising:
determining an order of the at least one of a plurality of secondary consoles for processing the data in said at least one of a plurality of secondary consoles.

3. The method for automatically populating a human resources database of claim 1, wherein the restricting access step is accomplished by:
selecting a restricted console from the primary console or at least one of a plurality of secondary consoles;
assigning a classification to a user for the restricted console wherein the classification is selected from the group consisting of unauthorized, authorized, and owner.

4. The method for automatically populating a human resources database of claim 3, wherein:
a user with the classification unauthorized may not access the restricted console;
a user with the classification authorized may view and modify the restricted console; and
a user with the classification owner may view, modify, or cancel the restricted console.

5. The method for automatically populating a human resources database of claim 4, further comprising
communicating with the user when input is required from the user.

6. The method for automatically populating a human resources database of claim 4, further comprising
changing the classification of a user when requested by the use.

7. The method for automatically populating a human resources database of claim 1, further comprising:
generating a summary of information wherein the summary of information is a subset of the employee data.

8. The method for automatically populating a human resources database of claim 1, further comprising:
providing a data sync table wherein the data sync table contains a number of records, each record representing a task to be completed by the primary console or one of the one or more secondary consoles.

9. The method for automatically populating a human resources database of claim 8, wherein each record comprises a unique identifier, a process to be completed, and a database to be updated.
